(19) United States
(12) Patent Application Publication
(10) Pub. No.: US 2006/0262989 A1
(43) Pub. Date: Nov. 23, 2006

(54) Image enhacement

(75) Inventors: Jeroen Arnoldus Paulus Tegenbosch, HOLSTLAAN (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/569,039

(22) PCT Filed: Aug. 10, 2004
(86) PCT No.: PCT/IB04/51433

§ 371 Date: Feb. 21, 2006

(30) Foreign Application Priority Data
Aug. 24, 2003 (EP) 03103219.6

(51) Int. Cl. G06K 9/40

(52) U.S. Cl. 382/261; 382/266

(57) ABSTRACT

A method of converting an input image into an enhanced output image is disclosed. The method comprises: detecting (606) whether a particular pixel of the input image corresponds to an edge in the input image; establishing (606) an orientation for the particular pixel; and computing a final pixel value of the enhanced output image, corresponding to the particular pixel, by means of an orientation dependent sharpening filtering operation on basis of the particular pixel and a number of pixels being located in spatial neighborhood of the particular pixel, the orientation dependent sharpening filtering having a first component (702) and a second component (704), a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

The invention relates to a method of converting an input image into an enhanced output image.

The invention further relates to an image conversion unit for converting an input image into an enhanced output image.

The invention further relates to an image processing apparatus comprising:

receiving means for receiving a signal corresponding to an input image; and

an image conversion unit for converting the input image into an enhanced output image.

The invention further relates to a computer program product to be loaded by a computer arrangement, comprising instructions to convert an input image into an enhanced output image, the computer arrangement comprising processing means and a memory.

An embodiment of the method of the kind described in the opening paragraph is known from chapter 2 of the book “Video Processing for multimedia systems”, by G. de Haan, University press Eindhoven, 2000. The purpose of image enhancement is to increase the subjective sharpness of the input image. Known sharpness enhancement methods fall into two categories:

methods for increasing the amplitude of high and/or middle spatial frequencies using linear filtering, usually fairly short FIR-filters. These methods are also referred as peaking methods;

methods that apply non-linear processing to increase the steepness of edges occurring in the images. These methods are usually indicated with edge enhancement or transient improvement.

Optionally, these edge enhancement methods comprise detection of edges and detection of the orientation of the detected edges. The transient improvement is preferably substantially orthogonal to the detected orientation. A disadvantage of these methods is that they result in rounding of corners of visualized objects in the image. A corner corresponds to the intersection of edges of the input image.

It is an object of the invention to provide a method of the kind described in the opening paragraph which substantially preserves corners in the image.

This object of the invention is achieved in that the method comprises:

establishing an orientation for a particular pixel of the input image; and

computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component and a second component, a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

It is known to determine an orientation of an edge and to perform an enhancement operation in a direction which is substantially orthogonal to the determined orientation. In general, this adaptive approach results in appropriate enhancement of edges. However, this known enhancement operation is inappropriate for some pixels being located on the edge, e.g. the corner points or end points of the edge. These points are located where the edge is intersected by a further edge. In such a case it is preferred that the enhancement is performed on basis of the orientations of both intersecting edges and not orthogonal to the particular orientation which is assigned to the particular pixel at the corner, by means of an orientation detector e.g. based on a Sobel filter. The inventors have observed that the two orientations of the intersecting edges can be approximated on basis of the orientation being established for the corner point, i.e. the particular pixel. The first approximation is assumed to have an angle of 45 degrees with the orientation which is assigned to the particular pixel at the corner and the second approximation is assumed to have an angle of 135 degrees with the orientation which is assigned to the particular pixel at the corner. In other words, preferably, the first predetermined value is substantially equal to 45 degrees (±5 degrees) and the second predetermined value is substantially equal to 135 degrees (±5 degrees). By performing two enhancement operations being orthogonal to the approximated orientations, the corners are relatively well preserved, i.e. with these predetermined values relatively well corner preservation is achieved, while they are enhanced.

Preferably the method further comprises detecting whether the particular pixel corresponds to an edge and optionally to an intersection of the edge and a further edge in the input image. As explained above, the method according to the invention is in particular relevant for corner pixels. However, the method can also be applied for other pixels on edges. By means of corner detection a distinction between types of edge pixels can be made: corresponding to a corner or not corresponding to a corner. The first type of edge pixels will be processed with the two filter operations as described. Optionally, the pixels of the other type are processed with an enhancement filter having a single direction of enhancement being orthogonal to the detected edge orientation.

In an embodiment of the method according to the invention, the first orientation and the second orientation are substantially mutually orthogonal (±10 degrees). Many edges in images are mutually intersecting with a substantially orthogonal angle.

An embodiment of the method according to the invention comprises:

computing a first intermediate pixel value by performing the first component of the orientation dependent sharpening filtering operation;

computing a second intermediate pixel value by performing the second component of the orientation dependent sharpening filtering operation; and

computing the final pixel value of the enhanced output image by combining the first intermediate pixel value and the second intermediate pixel value.

The enhancement in two different directions can be performed by means of a combined processing step, e.g. by means of convolution with a kernel having coefficients resulting in enhancement in two directions. In this embodiment according to the invention the enhancement is performed by means of two separate steps, which can be performed sequentially or in parallel. An advantage of this embodiment is that the two enhancements are independent of each other.

An embodiment of the method according to the invention, comprises:

computing an intermediate structure of samples by means of spatial interpolation of the particular pixel and the number of pixels being located in the spatial neighborhood of the particular pixel, the intermediate structure of samples comprising a first axis which has a third angle related to a first row of pixels of the input image, the third angle being based on the orientation being established for the particular pixel; and

performing the orientation dependent sharpening filtering operation on the intermediate structure of samples.

Typically, the selection of pixels in the spatial neighborhood of the particular pixel, for the computation of the intermediate structure is based on the orientation being established for the particular pixel. That means that primarily those pixels are selected from the input image which are located in the vicinity of a line segment through the particular pixel which is directed either in the first orientation or the second orientation. Alternatively, the selection of pixels in the spatial neighborhood of the particular pixel is fixed, e.g. all pixels being located in a block around the particular pixel. However in the latter case, the weighting factors for the different pixels are related to either the first orientation or the second orientation.

In an embodiment of the method according to the invention, the final pixel value is clipped between a first clip and a second clip value of a set of values based on the values of the particular pixel and the pixels being located in the spatial neighborhood of the particular pixel. The type of enhancement might be linear or non-linear. An advantage of a non-linear enhancement, e.g. based on clipping the output pixel values to input values of pixels in a neighborhood of the corresponding input pixel, is the image quality of the enhance output image.

It is a further object of the invention to provide an image conversion unit of the kind described in the opening paragraph which is arranged to substantially preserve corners in the image.

This object of the invention is achieved in that the image conversion unit comprises:

establishing an orientation for a particular pixel of the input image; and

computing means for computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component and a second component, a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

It is a further object of the invention to provide an image processing apparatus of the kind described in the opening paragraph which is arranged to substantially preserve corners in the image.

This object of the invention is achieved in that the image conversion unit comprises:

establishing an orientation for a particular pixel of the input image; and

computing means for computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component and a second component, a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

The image processing apparatus may comprise additional components, e.g. a display device for displaying the output images. The image processing apparatus might e.g. be a TV, a set top box, a VCR (Video Cassette Recorder) player, a satellite tuner, a DVD (Digital Versatile Disk) player or recorder.

It is a further object of the invention to provide a computer program product of the kind described in the opening paragraph which substantially preserves corners in the image.

This object of the invention is achieved in that the computer program product, after being loaded, provides said processing means with the capability to carry out:

establishing an orientation for a particular pixel of the input image; and

computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component and a second component, a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

Modifications of the image conversion unit and variations thereof may correspond to modifications and variations thereof of the image processing apparatus, the method and the computer program product, being described.

These and other aspects of the image conversion unit, of the image processing apparatus, of the method and of the computer program product, according to the invention will become apparent from and will be elucidated with respect to the implementations and embodiments described hereinafter and with reference to the accompanying drawings, wherein:

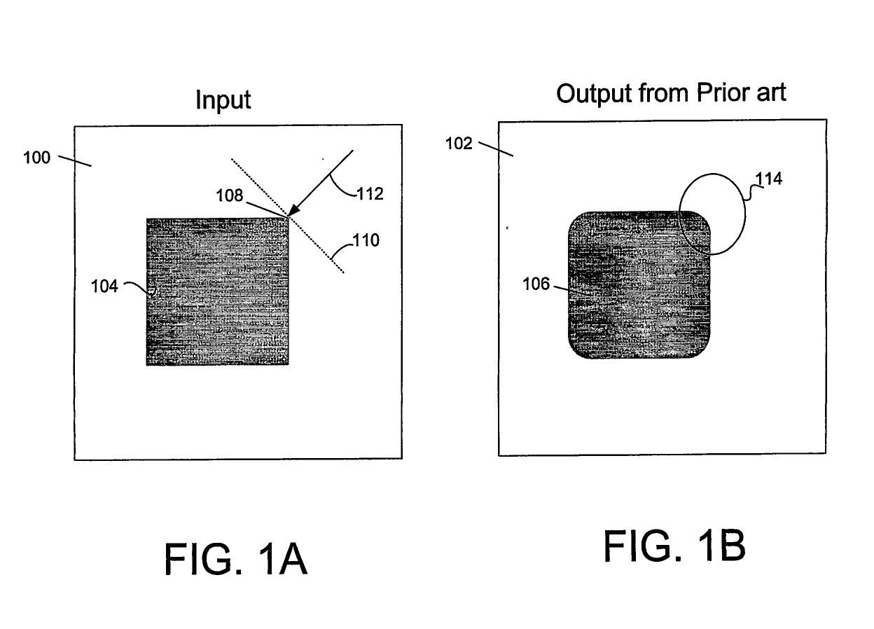

FIG. 1A schematically shows an input image representing a square object;

FIG. 1B schematically shows an enhanced output image based on the input image of FIG. 1A, being computed with an image conversion unit according to the prior art;

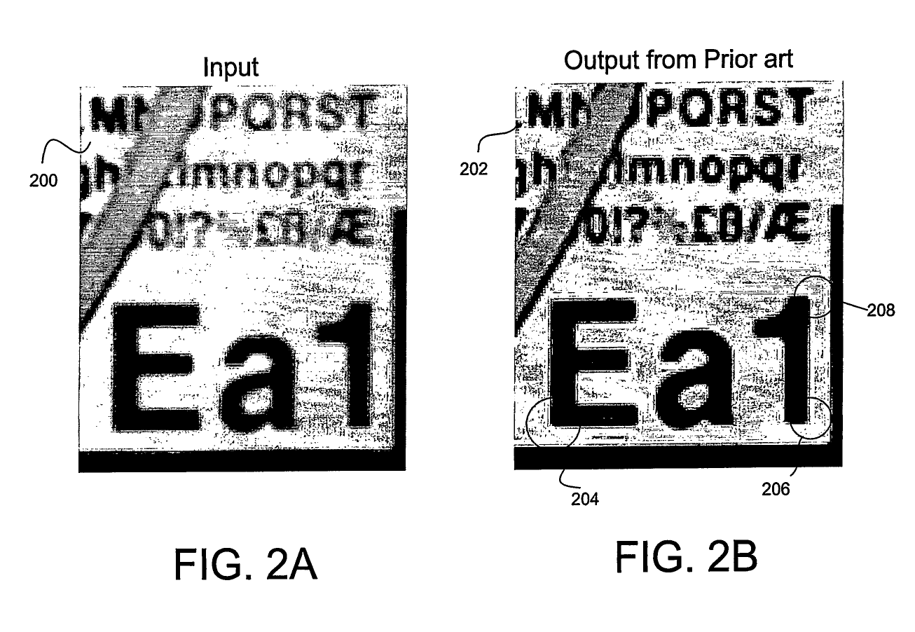

FIG. 2A schematically shows an input image representing text;

FIG. 2B schematically shows an enhanced output image based on the input image of FIG. 2A, being computed with an image conversion unit according to the prior art;

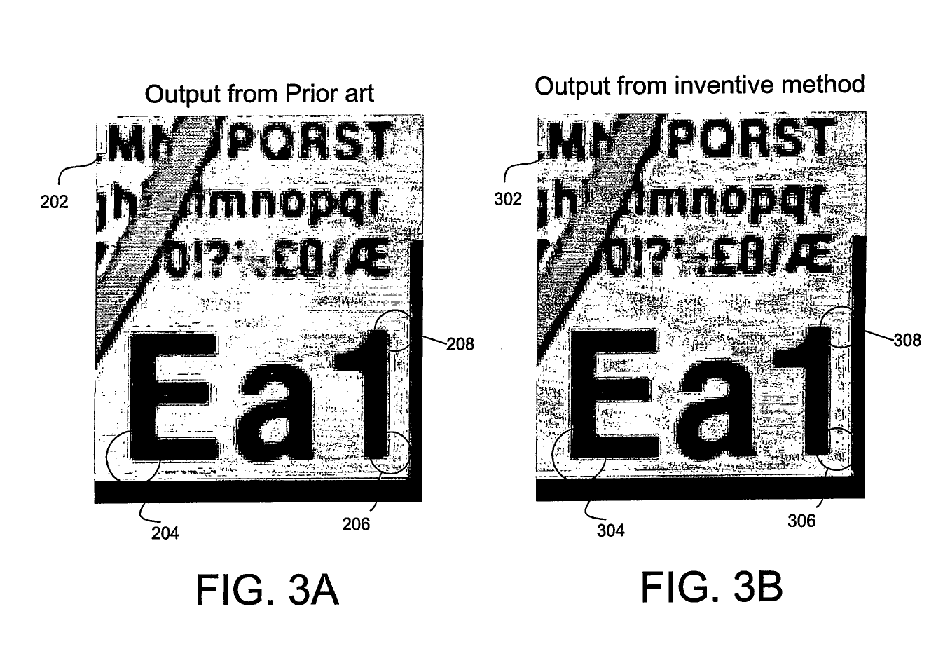

FIG. 3A schematically shows an enhanced output image based on the input image of FIG. 2A, being computed with an image conversion unit according to the prior art;

FIG. 3B schematically shows an enhanced output image based on the input image of FIG. 2A, being computed with an image conversion unit according to the invention;

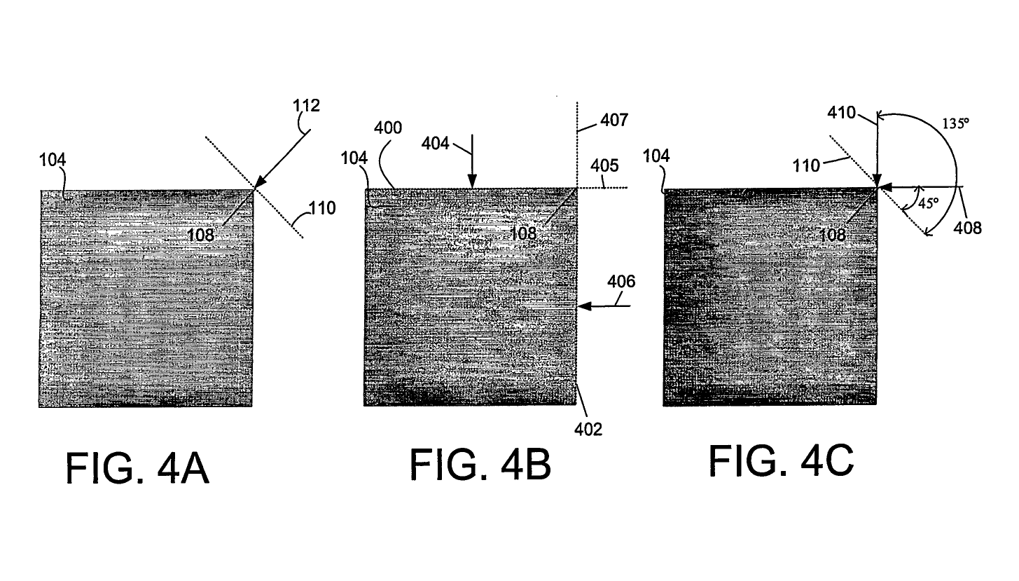

FIG. 4A schematically shows a square region of an image and the estimated edge orientation for a corner pixel of the region;

FIG. 4B schematically shows a square region of an image and two preferred enhancement directions for the edges of the region;

FIG. 4C schematically shows a square region of an image and two enhancement directions for a corner pixel of the region based on the estimated orientation of the corner pixel;

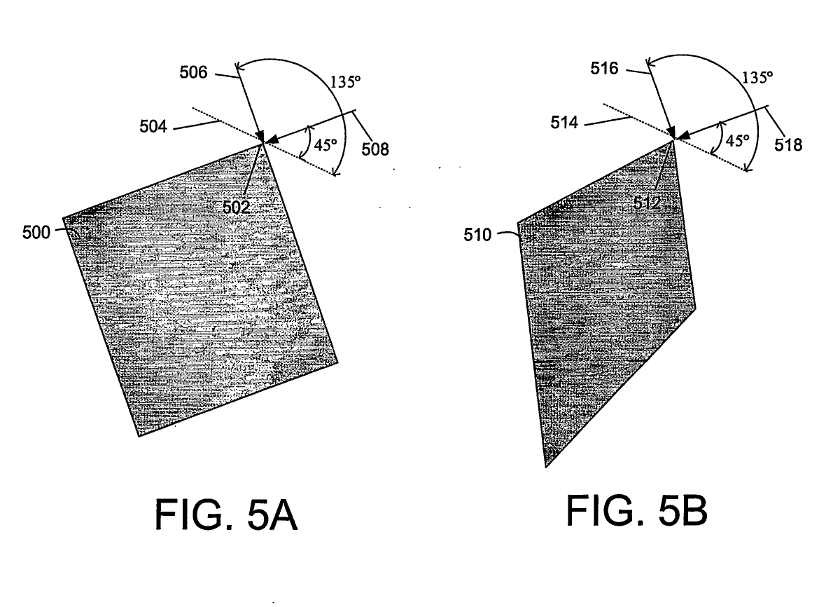

FIG. 5A schematically shows a square region of an image which is rotated related to the pixel matrix of the image and two enhancement directions for a corner pixel of the region based on the estimated orientation of the corner pixel;

FIG. 5B schematically shows another region of an image and two enhancement directions for a corner pixel of the region based on the estimated orientation of the corner pixel;

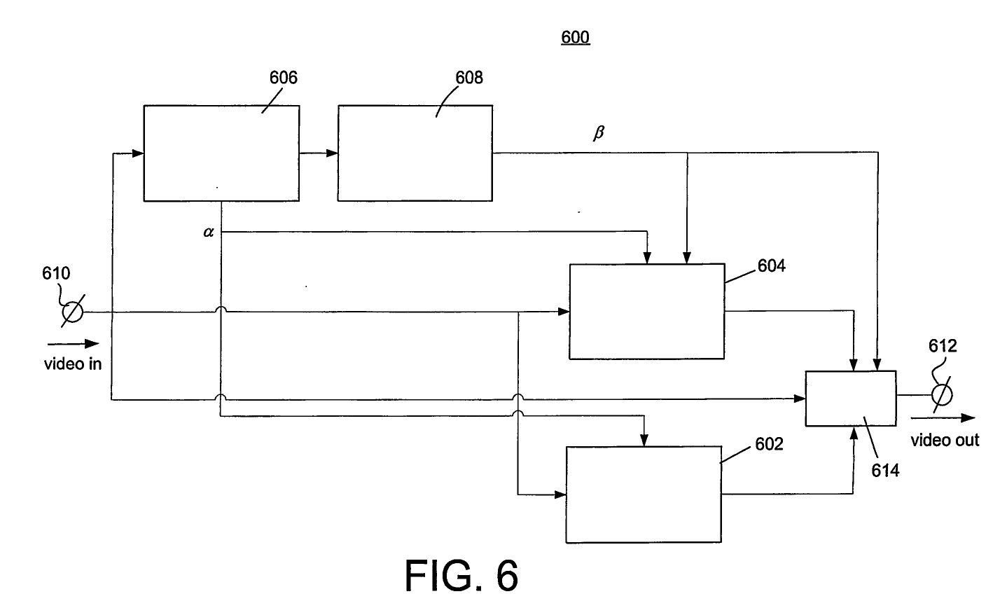

FIG. 6 schematically shows an embodiment of the image conversion unit according to the invention;

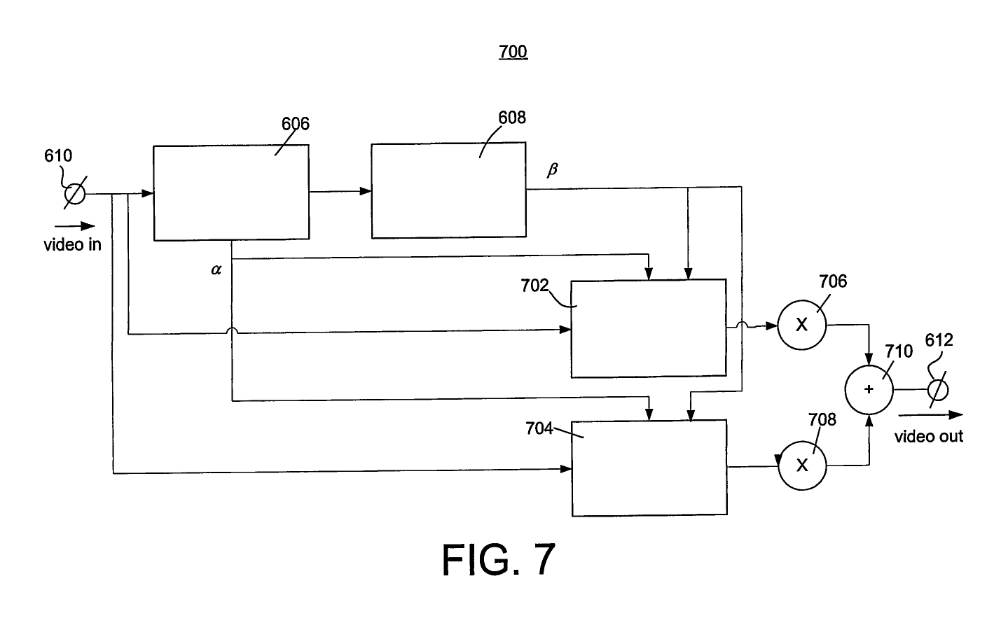

FIG. 7 schematically shows an alternative embodiment of the image conversion unit according to the invention; and

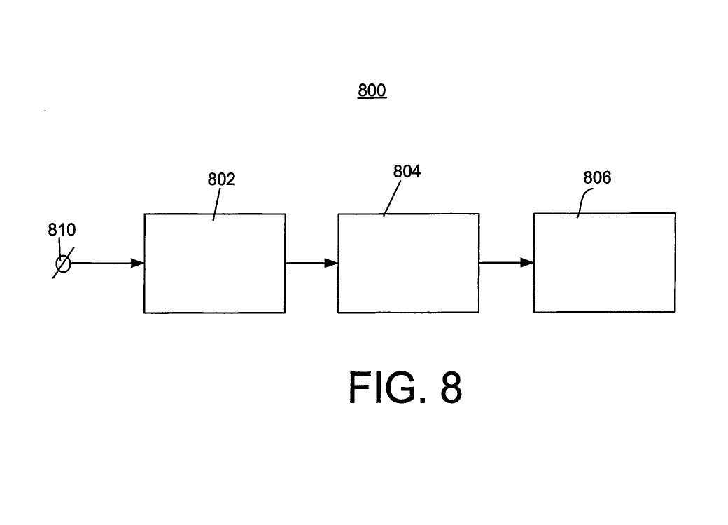

FIG. 8 schematically shows an embodiment of the image processing apparatus according to the invention.

Same reference numerals are used to denote similar parts throughout the Figures.

FIG. 1A schematically shows an input image 100 comprising a region 104 of pixels representing a square object. For a corner of the region 104, i.e. a particular pixel 108, the edge orientation is determined. This edge orientation is depicted with a dashed line 110. A typical prior art image conversion unit, being arranged to enhance edges performs edge enhancement perpendicular to the determined edge orientation, i.e. in the direction indicated with the arrow 112.

FIG. 1B schematically shows an enhanced output image 102 based on the input image of FIG. 1A, being computed with an image conversion unit according to the prior art. It can be clearly seen that the enhanced output image comprises a further region 106 of pixels with rounded corners, e.g. the upper-left corner 114. Comparing the region 104 of pixels of the input image, as depicted in FIG. 1A, with the region 106 of pixels, clearly illustrates that the known image conversion unit has a negative effect on the corners. That means that the corners are rounded.

FIG. 2A schematically shows an input image 200 representing text and FIG. 2B schematically shows an enhanced output image 202 based on the input image 200 of FIG. 2A. The enhanced output image 202 is computed with an image conversion unit according to the prior art. Again it can be observed that the known image conversion unit has a negative effect on the corners. E.g. the lower-left corner 204 of the character “E” is not jagged but rounded. The two right corners 206 and 208 are rounded too.

To observe the difference in image quality between a known image conversion unit and an image conversion unit according to the invention the two enhanced output images 202 and 302 of FIG. 3A and FIG. 3B, respectively, should be compared. FIG. 3A schematically shows an enhanced output image 202 based on the input image 200 of FIG. 2A, being computed with an image conversion unit according to the prior art. Notice that FIG. 3A and FIG. 2B are mutually equal. FIG. 3B schematically shows an enhanced output image 302 which is also based on the input image 200 of FIG. 2A, being computed with an image conversion unit according to the invention. Comparing the different corners 204-208 with the respective corners 304-308 clearly indicate the corner preservation capability of the image conversion unit according to the invention.

FIG. 4A schematically shows a square region 104 of an image and the estimated edge orientation 110 for a corner pixel 108 of the region 104. Besides that, the enhancement direction 112 being orthogonal to the estimated edge orientation 110 is depicted.

FIG. 4B schematically shows the same square region 104 of the image and two preferred enhancement directions 404 and 406 for the respective edges 400 and 402 of the region 104. These preferred enhancement directions 404 and 406 are substantially orthogonal to the respective edges 400 and 402 of the region 104. That means that for all pixels being located on the first edge 400, including the corner pixel 108, the enhancement should be in the direction as indicated with the first arrow 404 and that for all pixels being located on the second edge 402, also including the corner pixel 108, the enhancement should be in the direction as indicated with the second arrow 406. In other words, to enhance the corner pixel 108 in a first enhancement direction 404, preferably the pixels located on the dashed line segment 407 are used and to enhance the corner pixel 108 in a second enhancement direction 406, preferably the pixels located on the dashed line segment 405 are used.

FIG. 4C schematically shows the same square region 104 of the image and two enhancement directions 408 and 410 for the corner pixel 108 of the region 104 based on the estimated orientation 110 of the corner pixel 108. A first angle between a first enhancement direction 408 and the estimated orientation 110 of the corner pixel 108 is equal to a first predetermined value: 45°. A second angle between a second enhancement direction 410 and the estimated orientation 110 of the corner pixel 108 is equal to a second predetermined value: 135°. The first 408 and second enhancement direction 410 are mutually orthogonal. Notice that the first 408 and second enhancement direction 410 match with the preferred enhancement directions 404 and 406 as depicted in FIG. 4B.

FIG. 5A schematically shows a square region 500 of an image which is rotated related to the pixel matrix of the image and two enhancement directions 508 and 506 for another corner pixel 502 of the region 500. The two enhancement directions 508 and 506 are both based on the estimated orientation 504 of the corner pixel 502. The first angle between the first enhancement direction 508 and the estimated orientation 504 of the corner pixel 502 is equal to the first predetermined value: 45°. The second angle between the second enhancement direction 516 and the estimated orientation 514 of the corner pixel 512 is equal to the second predetermined value: 135°.

FIG. 5B schematically shows another region 510 of an image and two enhancement directions 518 and 516 for yet another corner pixel 512. The two enhancement directions 518 and 516 are both based on the estimated orientation 514 of the corner pixel 512. Notice that the two enhancement directions 518 and 516 are mutually orthogonal, although the two edges intersecting at the corner pixel 512 are not mutually orthogonal.

FIG. 6 schematically shows an embodiment of the image conversion unit 600 according to the invention. The image conversion unit 600 is provided with an input video signal representing a series of input images, at its input connector 610 and is arranged to provide an output video signal representing a series of enhanced output images, at its output connector 612. The image conversion unit 600 comprises:

an edge detection unit 606 for detecting edges in the input images and assigning estimated edge orientations α to the set of pixels being located on the edges;

a corner detection unit 608 for detecting corner pixels in the input images;

a first filter unit 602 being arranged to enhance a detected edge by processing in a direction which is substantially perpendicular to the estimated edge orientation α;

a second filter unit 604 being arranged to enhance a detected edge by processing in two directions which are mutually substantially perpendicular. A first one of the directions making a first angle, being equal with a first predetermined value, with the estimated edge orientation α of a pixel under consideration. A second one of the directions making a second angle, being equal with a second predetermined value, with the estimated edge orientation α of the pixel under consideration, and

a combining unit 614 for combining the first intermediate filter output of the first filter unit 602 with the second intermediate filter output of the second filter unit 604.

The edge detection unit 606 is preferably based on a combination of Sobel filters of which the kernel coefficients are:

$$\vert \begin{matrix}- 1 & 0 & 1 \\ - 1 & 0 & 1 \\ - 1 & 0 & 1\end{matrix} \vert and \vert \begin{matrix}- 1 & - 1 & - 1 \\ 0 & 0 & 0 \\ 1 & 1 & 1\end{matrix} \vert or \vert \begin{matrix}- 1 & 0 & 1 \\ - 2 & 0 & 2 \\ - 1 & 0 & 1\end{matrix} \vert and \vert \begin{matrix}- 1 & - 2 & - 1 \\ 0 & 0 & 0 \\ 1 & 2 & 1\end{matrix} \vert$$

The edge detection unit 606 further comprises means for clipping minor output signals of the Sobel filters and computing means for computing the ratio between the two clipped outputs of the two Sobel filters.

Preferably, the corner detection unit 608 is connected to the edge detection unit 606, as depicted in FIG. 6. That means that the set of pixels for which the corner detection unit 608 is testing whether the pixels correspond to corner points, is limited. Alternatively, the corner detection unit 608 is performing the detection on all pixels of the input images. A preferred corner detection unit is disclosed in the article “SUSAN—a New Approach to Low Level Image Processing”, by S. M. Smith and J. M. Brady, in International Journal Of Computer Vision. 23(1), pp. 45-78, May 1997.

The corner detection unit 608 is arranged to provide a two-dimensional array of probability values β to the first filter unit 602. These probability values indicate the probability that the respective pixels correspond to a corner point, so 0≦6≦1. The two-dimensional array of probability values β is also provided to the combining unit 614. The output of the combining unit 614 is primarily based on the output of the first filter unit 602 for relatively low values of β and the output of the combining unit 614 is primarily based on the output of second filter unit 604 for relatively high values of β.

The working of the image conversion unit 600 is as follows. In an incoming image the edges are detected by means of the edge detection unit 606. The estimated edge orientations a are assigned to the edge set of pixels being located on the edges and provided to the first filter unit 602 and the second filter unit 604. The output of the edge detection unit 606 is provided to the corner detection unit 608. For the pixels of the corner set of pixels, i.e. for which the respective probability values β are above zero, the second filter unit 604 performs the edge enhancement in the two directions, which are based of the estimated edge orientations. For the pixels of the edge set of pixels the first filter unit 602 performs an edge enhancement in a single direction which is orthogonal to the respective estimated edge orientations. The combining unit 614 merges the output of the first filter unit 602 and the second filter unit 604, and optionally a portion of the input signal. Alternatively, the first filter unit 602 and the second filter unit 604 are arranged to process all pixels of the incoming images, whereby the amount of enhancement is related to the detected edges.

The first filter unit 602, the second filter unit 604, the edge detection unit 606, the corner detection unit 608 and the combining unit 614 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 7 schematically shows an alternative embodiment of the image conversion unit 700 according to the invention. The image conversion unit 700 is provided with an input video signal representing a series of input images, at its input connector 610 and is arranged to provide an output video signal representing a series of enhanced output images, at its output connector 612. The image conversion unit 700 comprises:

an edge detection unit 606 for detecting edges in the input images and assigning estimated edge orientations α to the set of pixels being located on the edges;

a corner detection unit 608 for detecting corner pixels in the input images;

a first enhancement unit 702 for computing a first intermediate result by performing a first orientation dependent sharpening filtering operation;

a second enhancement unit 704 for computing a second intermediate result by performing a second orientation dependent sharpening filtering operation; and

merging means for computing the final pixel values of the enhanced output image by combining the first intermediate result and the second intermediate result. The merging means comprises two multipliers 706 and 708 and an adding unit 710.

The working of the image conversion unit 700 is as follows. In an incoming image the edges are detected by means of the edge detection unit 606. The estimated edge orientations α are assigned to the edge set of pixels being located on the edges and provided to the first enhancement unit 702 and the second enhancement unit 704. The output of the edge detection unit 606 is provided to the corner detection unit 608. The first enhancement unit 702 performs a first orientation dependent sharpening filtering operation, whereby the first angle between the first enhancement orientation of the first enhancement unit 702 and the estimated edge orientations assigned to the pixels is equal to a first predetermined value: 45°. The second enhancement unit 704 performs a second orientation dependent sharpening filtering operation, whereby the second angle between the second enhancement orientation of the second enhancement unit 704 and the estimated edge orientations assigned to the pixels is equal to a second predetermined value: 135°. The merging means merges the output of the first enhancement unit 702 and the second enhancement unit 704.

The first enhancement unit 702, the second enhancement unit 704, the edge detection unit 606, the corner detection unit 608, the two multipliers 706, 708 and the adding unit 710 may be implemented using one processor.

The edge enhancement being performed by means of the first filter unit 602, the second filter unit 604, the first enhancement unit 702 and the second enhancement unit 704 is preferably based on the method as described in patent application WO2003053045.

FIG. 8 schematically shows an embodiment of the image processing apparatus 800 according to the invention, comprising:

receiving means 802 for receiving a signal representing input images;

the image conversion unit 804 for converting the input images into enhanced output images, as described in connection with one of the FIGS. 6 and 7; and

a display device 806 for displaying the output images of the image conversion unit 804.

The signal may be a broadcast signal received via an antenna or cable but may also be a signal from a storage device like a VCR (Video Cassette Recorder) or Digital Versatile Disk (DVD). The signal is provided at the input connector 810. The image processing apparatus 800 might e.g. be a TV. Alternatively the image processing apparatus 800 does not comprise the optional display device but provides the output images to an apparatus that does comprise a display device 806. Then the image processing apparatus 800 might be e.g. a set top box, a satellite-tuner, a VCR player, a DVD player or recorder. Optionally the image processing apparatus 800 comprises storage means, like a hard-disk or means for storage on removable media, e.g. optical disks. The image processing apparatus 800 might also be a system being applied by a film-studio or broadcaster.

The method of converting an input image into an enhanced output image as described above is typically performed for images which have been spatially up-converted, or will be spatially up-converted. Alternatively, the method of converting an input image into an enhanced output image is combined with a method of spatial up-conversion. That means that the input image and the enhanced output image might have mutually equal resolutions but alternatively different resolutions. E.g. the enhanced output image might have a higher resolution than the input image.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A method of converting an input image into an enhanced output image, the method comprising:
establishing an orientation for a particular pixel of the input image; and
computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component and a second component, a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

2. A method as claimed in claim 1, further comprising detecting whether the particular pixel corresponds to an edge in the input image.

3. A method as claimed in claim 2, further comprising detecting whether the particular pixel corresponds to an intersection of the edge and a further edge in the input image.

4. A method as claimed in claim 1, wherein the first orientation and the second orientation are substantially mutually orthogonal.

5. A method as claimed in claim 1, wherein the first predetermined value is substantially equal to 45 degrees.

6. A method as claimed in claim 1, wherein the second predetermined value is substantially equal to 135 degrees.

7. A method as claimed in claim 1, comprising:
computing a first intermediate pixel value by performing the first component of the orientation dependent sharpening filtering operation;
computing a second intermediate pixel value by performing the second component of the orientation dependent sharpening filtering operation; and
computing the final pixel value of the enhanced output image by combining the first intermediate pixel value and the second intermediate pixel value.

8. A method as claimed in claim 1, comprising:
computing an intermediate structure of samples by means of spatial interpolation of the particular pixel and the number of pixels being located in the spatial neighborhood of the particular pixel, the intermediate structure of samples comprising a first axis which has a third angle related to a first row of pixels of the input image, the third angle being based on the orientation being established for the particular pixel; and
performing the orientation dependent sharpening filtering operation on the intermediate structure of samples.

9. A method as claimed in claim 1, wherein the final pixel value is clipped between a first clip and a second clip value of a set of values based on the values of the particular pixel and the pixels being located in the spatial neighborhood of the particular pixel.

10. An image conversion unit (700) for converting an input image into an enhanced output image, the image conversion unit comprising:
establishing means (606) for establishing an orientation for a particular pixel of the input image; and
computing means (702-710) for computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component (702) and a second component (704), a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

11. An image processing apparatus (800) comprising:
receiving means (802) for receiving a signal corresponding to an input image; and
an image conversion unit (700) for converting the input image into an enhanced output image, the image conversion unit comprising:
establishing means (606) for establishing an orientation for a particular pixel of the input image; and
computing means (702-710) for computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component (702) and a second component (704), a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.

12. An image processing apparatus (800) as claimed in claim 11, further comprising a display device (806) for displaying the enhanced output image.

13. A computer program product to be loaded by a computer arrangement, comprising instructions to convert an input image into an enhanced output image, the computer arrangement comprising processing means and a memory, the computer program product, after being loaded, providing said processing means with the capability to carry out:
establishing an orientation for a particular pixel of the input image; and
computing a final pixel value of the enhanced output image, corresponding to the particular pixel, by means of an orientation dependent sharpening filtering operation on basis of the particular pixel and a number of pixels being located in a spatial neighborhood of the particular pixel, the orientation dependent sharpening filtering having a first component and a second component, a first angle between a first orientation of the first component and the established orientation of the particular pixel being equal to a first predetermined value and a second angle between a second orientation of the second component and the established orientation of the particular pixel being equal to a second predetermined value, the second orientation and the first orientation being mutually different.
